(19) United States
(12) Patent Application Publication
(10) Pub. No.: US 2025/0150775 A1
(43) Pub. Date: May 8, 2025

(54) OUTPUT OF AUDIO SIGNALS

(71) Applicant: Nokia Technologies Oy, Espoo (FI)

(72) Inventors: Arto Juhani LEHTINIEMI, Tampere (FI); Antti Johannes ERONEN, Tampere (FI); Miikka Tapani VILERMO, Tampere (FI)

(21) Appl. No.: 18/922,086

(22) Filed: Oct. 21, 2024

(30) Foreign Application Priority Data
Nov. 3, 2023 (GB) 2316867.7

(51) Int. Cl. H04S 7/00; H04R 5/02; H04R 5/033; H04R 25/00

(52) U.S. Cl. CPC H04S 7/304; H04R 5/02; H04R 5/033; H04R 25/40

(57) ABSTRACT

Example embodiments relate to output of audio signals and particularly to rendering of one or more sound sources represented by such audio signals using two or more physical loudspeakers. In an example method, there is disclosed a method, comprising rendering, by output of audio signals from two or more physical loudspeakers having different respective positions, at least a first sound source such that the first sound source is intended to be perceived as having a first direction with respect to a user which is other than a physical loudspeaker direction. The method may also comprise detecting that an audio capture device of the user operates in a directivity mode for steering a sound capture beam towards the first direction. The method may also comprise, responsive to the detecting, performing modified rendering by outputting audio signals of the first sound source from a selected one of the two or more physical loudspeakers and not from the other physical loudspeaker(s) such that the first sound source will be perceived from the direction of the selected physical loudspeaker thereby to cause the sound capture beam to be steered towards the selected physical loudspeaker.

### FIELD

Example embodiments relate to output of audio signals and particularly to rendering of one or more sound sources represented by such audio signals using two or more physical loudspeakers.

### BACKGROUND

Certain audio signal formats are suited to output by two or more physical loudspeakers. Such audio signal formats may include stereo, multichannel and immersive formats. By output of audio signals using two or more physical loudspeakers, listening users may perceive one or more sound objects as coming from a particular direction which is other than a direction of a physical loudspeaker.

Users who wear certain audio capture devices when listening to audio signals output by two or more physical loudspeakers may not get an optimum user experience.

### SUMMARY OF THE INVENTION

The scope of protection sought for various embodiments of the invention is set out by the independent claims. The embodiments and features, if any, described in this specification that do not fall under the scope of the independent claims are to be interpreted as examples useful for understanding various embodiments of the invention.

A first aspect provides an apparatus comprising: means for rendering, by output of audio signals from two or more physical loudspeakers having different respective positions, at least a first sound source such that the first sound source is intended to be perceived as having a first direction with respect to a user which is other than a physical loudspeaker direction; and means for detecting that an audio capture device of the user operates in a directivity mode for steering a sound capture beam towards the first direction, wherein the means for rendering is configured, responsive to the detecting, to perform modified rendering by outputting audio signals of the first sound source from a selected one of the two or more physical loudspeakers and not from the other physical loudspeaker(s) such that the first sound source will be perceived from the direction of the selected physical loudspeaker thereby to cause the sound capture beam of the audio capture device to be steered towards the selected physical loudspeaker.

The selected physical loudspeaker may be that which has a direction with respect to the user that is closest to the first direction.

The apparatus may further comprise: means for detecting that the first sound source is of interest to the user, wherein the means for rendering is further configured to perform the modified rendering in response to detecting that the audio capture device operates in a directivity mode only if the first sound source is detected to be of interest to the user.

The means for detecting that the first sound source is of interest to the user may be configured to detect that the first sound source is a predetermined type of sound. The predetermined type of sound may speech-type sound.

The apparatus may further comprise means for determining a head direction of the user, wherein the means for detecting that the first sound source is of interest to the user is configured to detect that the first direction is within a predetermined angular range of the head direction of the user.

The means for rendering may be configured to render, by output of other audio signals from the two or more physical loudspeakers, one or more other sound sources such that they are intended to be perceived as coming from respective directions with respect to the user, and

wherein the modified rendering so that the first sound source will be perceived from the direction of the selected physical loudspeaker may be performed only for the first sound source and not the other sound sources.

The apparatus may further comprise: means for determining that, for said other audio signals of said one or more other sound sources, a first set of said other audio signals are, or are intended to be, output only by the selected physical loudspeaker and a second set of said other audio signals are, or are intended to be, output by one or more other physical loudspeakers, and wherein the means for rendering may be configured, responsive to said determination, to perform other modified rendering of said first set of other audio signals and/or said second set of other audio signals of the one or more other sound sources.

The said other modified rendering may comprise rendering said first set of audio signals for the one or more other sound sources with reduced reverberation and/or rendering said second set of audio signals for the one or more other sound sources with increased reverberation.

The said other modified rendering may comprise outputting said first set of audio signals for the one or more other sound sources from a different physical loudspeaker.

For a particular other sound source, the different physical loudspeaker may be that which has a direction with respect to the user that is closest to the direction of said particular other sound source with respect to the user.

The said other modified rendering may comprise rendering said first set of audio signals for the one or more other sound sources by rendering them at reduced volume(s).

The apparatus may further comprise: means for determining respective types of audio content which comprise the first sound source and the one or more other sound sources; and means for determining an amount of said other modified rendering to perform based on the determined respective types of audio content.

The apparatus may further comprise: means for receiving metadata associated with audio content which comprises the first sound source and the one or more other sound sources; and means for determining an amount of said other modified rendering to perform based on the received metadata.

The means for rendering of the at least first audio source may comprise an MPEG-I renderer.

A second aspect provides a method comprising: rendering, by output of audio signals from two or more physical loudspeakers having different respective positions, at least a first sound source such that the first sound source is intended to be perceived as having a first direction with respect to a user which is other than a physical loudspeaker direction; detecting that an audio capture device of the user operates in a directivity mode for steering a sound capture beam towards the first direction; and responsive to the detecting, performing modified rendering by outputting audio signals of the first sound source from a selected one of the two or more physical loudspeakers and not from the other physical loudspeaker(s) such that the first sound source will be perceived from the direction of the selected physical loudspeaker thereby to cause the sound capture beam of the audio capture device to be steered towards the selected physical loudspeaker.

The selected physical loudspeaker may be that which has a direction with respect to the user that is closest to the first direction.

The method may further comprise detecting that the first sound source is of interest to the user, wherein the modified rendering is performed in response to detecting that the audio capture device operates in a directivity mode only if the first sound source is detected to be of interest to the user.

The detecting that the first sound source is of interest to the user may comprise detecting that the first sound source is a predetermined type of sound. The predetermined type of sound may speech-type sound.

The method may further comprise determining a head direction of the user, wherein the detecting that the first sound source is of interest to the user may comprise detecting that the first direction is within a predetermined angular range of the head direction of the user.

The rendering may comprise rendering, by output of other audio signals from the two or more physical loudspeakers, one or more other sound sources such that they are intended to be perceived as coming from respective directions with respect to the user, and

wherein the modified rendering so that the first sound source will be perceived from the direction of the selected physical loudspeaker may be performed only for the first sound source and not the other sound sources.

The method may further comprise: determining that, for said other audio signals of said one or more other sound sources, a first set of said other audio signals are, or are intended to be, output only by the selected physical loudspeaker and a second set of said other audio signals are, or are intended to be, output by one or more other physical loudspeakers, and wherein the rendering may comprise, responsive to said determination, other modified rendering of said first set of other audio signals and/or said second set of other audio signals of the one or more other sound sources.

The said other modified rendering may comprise rendering said first set of audio signals for the one or more other sound sources with reduced reverberation and/or rendering said second set of audio signals for the one or more other sound sources with increased reverberation.

The said other modified rendering may comprise outputting said first set of audio signals for the one or more other sound sources from a different physical loudspeaker to the selected physical loudspeaker.

For a particular other sound source, the different physical loudspeaker may be that which has a direction with respect to the user that is closest to the direction of said particular other sound source with respect to the user.

The said other modified rendering may comprise rendering said first set of audio signals for the one or more other sound sources by rendering the, at reduced volume(s).

The method may further comprise determining respective type(s) of audio content which comprise the first sound source and the one or more other sound sources; and determining an amount of said other modified rendering to perform based on the determined respective type(s) of audio content.

The method may further comprise: receiving metadata associated with audio content which comprises the first sound source and the one or more other sound sources; and determining an amount of said other modified rendering to perform based on the received metadata.

The rendering of the at least first audio source may be performed by an MPEG-I renderer.

A third aspect of provides a computer program comprising a set of instructions which, when executed on an apparatus, is configured to cause the apparatus to carry out a method comprising: rendering, by output of audio signals from two or more physical loudspeakers having different respective positions, at least a first sound source such that the first sound source is intended to be perceived as having a first direction with respect to a user which is other than a physical loudspeaker direction; detecting that an audio capture device of the user operates in a directivity mode for steering a sound capture beam towards the first direction; and responsive to the detecting, performing modified rendering by outputting audio signals of the first sound source from a selected one of the two or more physical loudspeakers and not from the other physical loudspeaker(s) such that the first sound source will be perceived from the direction of the selected physical loudspeaker thereby to cause the sound capture beam of the audio capture device to be steered towards the selected physical loudspeaker.

In some example embodiments, the third aspect may include any other feature mentioned with respect to the method of the second aspect.

A fourth aspect of the invention provides a non-transitory computer-readable medium having stored thereon computer-readable code, which, when executed by at least one processor, causes the at least one processor to perform a method, comprising: rendering, by output of audio signals from two or more physical loudspeakers having different respective positions, at least a first sound source such that the first sound source is intended to be perceived as having a first direction with respect to a user which is other than a physical loudspeaker direction; detecting that an audio capture device of the user operates in a directivity mode for steering a sound capture beam towards the first direction; and responsive to the detecting, performing modified rendering by outputting audio signals of the first sound source from a selected one of the two or more physical loudspeakers and not from the other physical loudspeaker(s) such that the first sound source will be perceived from the direction of the selected physical loudspeaker thereby to cause the sound capture beam of the audio capture device to be steered towards the selected physical loudspeaker.

The fourth aspect may include any other feature mentioned with respect to the method of the second aspect.

A fifth aspect of the invention provides an apparatus, the apparatus having at least one processor and at least one memory having computer-readable code stored thereon which when executed controls the at least one processor: to render, by output of audio signals from two or more physical loudspeakers having different respective positions, at least a first sound source such that the first sound source is intended to be perceived as having a first direction with respect to a user which is other than a physical loudspeaker direction; to detecting that an audio capture device of the user operates in a directivity mode for steering a sound capture beam towards the first direction; and responsive to the detecting, to perform modified rendering by outputting audio signals of the first sound source from a selected one of the two or more physical loudspeakers and not from the other physical loudspeaker(s) such that the first sound source will be perceived from the direction of the selected physical loudspeaker thereby to cause the sound capture beam of the audio capture device to be steered towards the selected physical loudspeaker.

The fifth aspect may include any other feature mentioned with respect to the method of the second aspect.

### BRIEF DESCRIPTION OF THE DRAWINGS

The invention will now be described, by way of non-limiting example, with reference to the accompanying drawings, in which:

FIG. 1 is a is a schematic illustration of a system for rendering which is useful for understanding one or more example embodiments;

FIG. 2 is a schematic illustration of the FIG. 1 system indicating a direction of one sound source with respect to a user;

FIG. 3 is a schematic illustration of an audio capture device which is useful for understanding one or more example embodiments;

FIG. 4 is a flow diagram showing operations according to one or more example embodiments;

FIG. 5 is a schematic illustration of a system for rendering audio according to one or more example embodiments;

FIG. 6 is a schematic illustration of a system for rendering audio according to one or more other example embodiments;

FIG. 7 is a schematic illustration of a system for rendering audio according to one or more other example embodiments;

FIG. 8 is a schematic illustration of a system for rendering audio according to one or more other example embodiments;

FIG. 9 is a block diagram of an apparatus that may be configured in accordance with one or more example embodiments; and

FIG. 10 is a non-transitory computer readable medium in accordance with one or more example embodiments.

### DETAILED DESCRIPTION

Example embodiments relate to rendering of one or more sound sources using two or more physical loudspeakers.

Example embodiments focus on immersive audio but it should be appreciated that other audio formats for output by two or more physical loudspeakers, including, but not limited to, stereo and multi-channel audio formats, are also applicable.

Immersive audio in this context may refer to any technology which renders sound objects in a space such that listening users in that space may perceive one or more sound objects as coming from respective direction(s) in the space. Users may also perceive a sense of depth.

Immersive audio in this context may include any technology, such as surround sound and different types of spatial audio technology that utilise two or more physical loudspeakers having respective spaced-apart positions to provide an immersive audio experience. Ambisonics and MPEG-I are example immersive audio formats, but example embodiments are not limited to such examples.

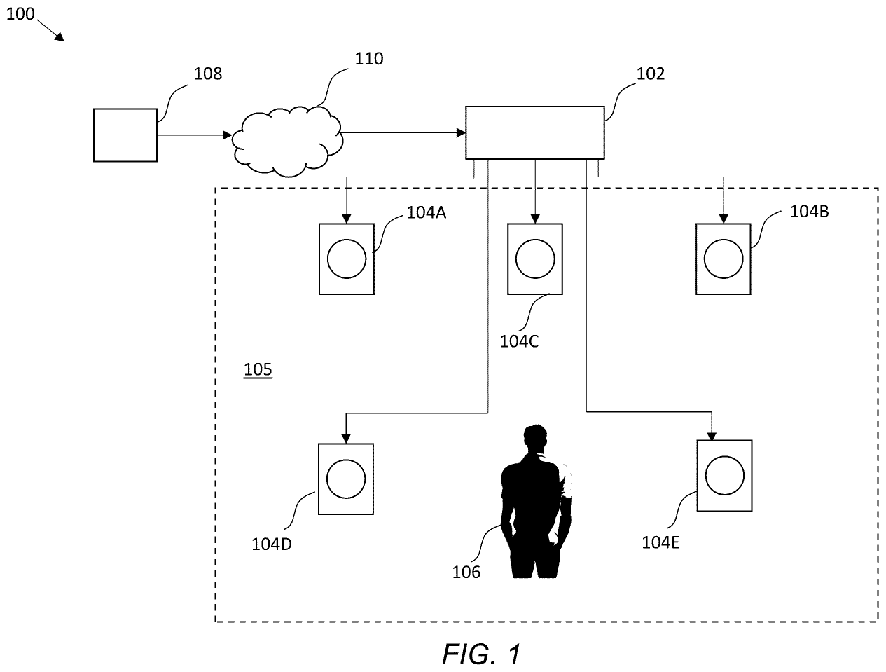

FIG. 1 shows a system 100 for output of immersive audio, the system comprising an audio processor 102 (sometimes referred to as an audio receiver or audio amplifier) and first to fifth physical loudspeakers 104A-104E (hereafter “loudspeakers”) which are spaced-apart and have respective positions in a listening space 105 which may be a room. The first, second and third loudspeakers 104A, 104B, 104C may be termed front-left, front-right and front-centre loudspeakers based on their respective positions with respect to a typical listening position, indicated by reference numeral 106. Similarly, the fourth and fifth loudspeakers 104D, 104E may be termed rear-left and rear-right loudspeakers based on their respective positions with respect to said listening position 106. There may also be a further loudspeaker, not shown, for output of lower frequency audio signals and this may be known as a sub-woofer, bass speaker or similar. In some example embodiments, there may be fewer loudspeakers. The system 100 may therefore represent a 5.1 surround sound set-up but it will be appreciated that there are numerous other set-ups such as, but not limited to, 2.0, 2.1, 3.1, 4.0, 4.1, 5.1, 6.1, 7.1, 7.1.2, 7.2, 9.1, 9.1.2, 10.2 and 13.1.

The audio processor 102 may be configured to store audio data representing immersive audio content for output via the first to fifth loudspeakers 104A-104E. The audio processor 102 may comprise, amplifiers, signal processing functions, one or more memories, e.g. a hard disk drive (HDD) and/or a solid state drive (SSD) for storing audio data. The audio processor 102 may be provided in any suitable form, such as a set-top box, a mobile phone, a tablet computer or similar. The audio processor 102 may be a digital-only processor in which case it may not comprise amplifiers. For example, the audio data may be received from a remote source 108 over a network 110 and stored on the one or more memories. The network 110 may comprise the Internet. The audio data may be received via a wired or wireless connection to the network 110 such as via a home router or hub. Alternatively, the audio data may be streamed from the remote source 108 using a suitable streaming protocol, e.g. the real-time streaming protocol (RTSP) or similar. Alternatively, audio data may be provided on a non-transitory computer-readable medium such as an optical disk, memory card, memory stick or removable hard drive which is inserted, or connected, to a suitable part of the audio processor 102.

The audio data may represent audio signals for any form of audio, whether speech, singing, music, ambience or a combination thereof. The audio data may be associated with video data, for example as part of a video clip, video game or movie.

The audio processor 102 may be configured to render the audio data by output of audio signals using appropriate ones of the first to fifth loudspeakers 104A-104E. The audio processor 102 may therefore comprise a rendering means which may comprise hardware, software and/or firmware configured to process (or render) and output the audio signals to said appropriate ones of the first to fifth loudspeakers 104A-104E. The audio processor 102 may also provide other signal processing functionality such as to modify overall volume, modify respective volumes for different frequency ranges and/or perform certain effects, such as to modify reverberation and/or perform panning such as Vector Base Amplitude Panning (VBAP). VBAP is a method for positioning sound sources to arbitrary directions using the current loudspeaker setup; the number of loudspeakers is arbitrary as they can be positioned in 2 or 3-dimensional setups. VBAP produces virtual sources that are localized to a relatively narrow region. VBAP processing may involve finding a loudspeaker triplet, i.e., three loudspeakers, enclosing a desired sound source panning position, and then calculating gains to be applied to audio signals for said sound source such that it will be reproduced using the three loudspeakers. The audio processor 102 may for example implement VBAP. An alternative method is Speaker-Placement Correction Amplitude Panning (SPCAP).

The audio data may include metadata or other computer-readable indications which the audio processor 102 processes to determine how the audio signals are to be rendered, for example by which of the first to fifth loudspeakers 104A-104E. The audio signals may be arranged into channels, e.g. one for each of the first to fifth loudspeakers 104A-104E.

In some cases, only a subset of the first to fifth loudspeakers 104A-104E may be used.

In some cases, the metadata or other computer-readable indications may determine certain effects to be applied to which audio signals at certain times during output of the audio data. For example, the audio data may accompany a movie where certain channels or sound sources may be amplified, attenuated or have certain effects, such as panning and/or reverberation modification, used at certain times.

The audio processor 102, by output of audio signals from two or more of the first to fifth loudspeakers 104A-104E, may render a sound source so that it will be perceived by a user as coming from a direction with respect to that user which is other than the direction of (any of) the first to fifth loudspeakers.

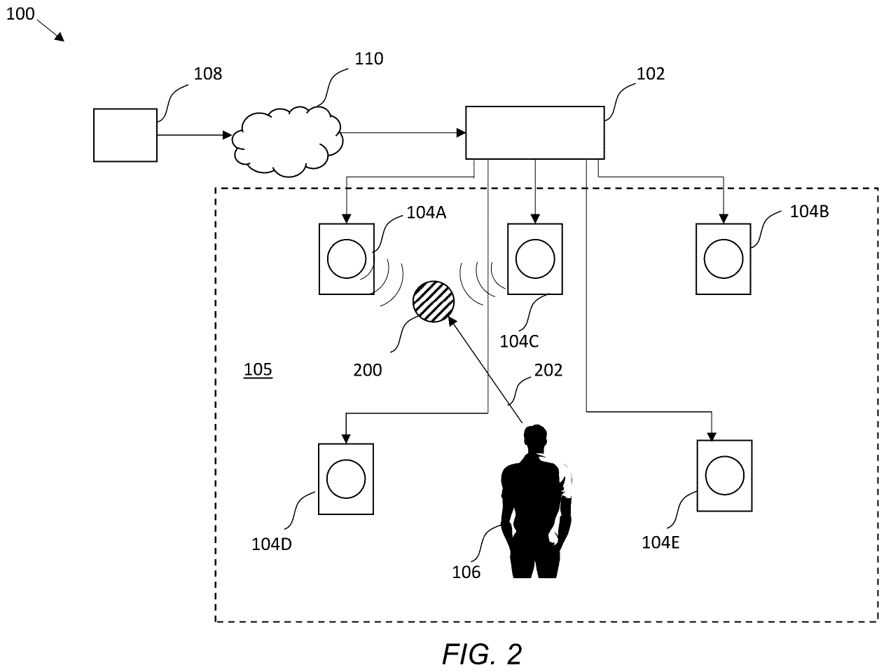

FIG. 2 shows the FIG. 1 system with a first sound source 200 indicated at a position between the first and third loudspeakers 104A, 104C such that it will be perceived by the user at position 106 as coming from a first direction 202 with respect to that user.

In this example, the audio processor 102 may render the first sound source 200 by means of VBAP or similar using the first and third loudspeakers 104A, 104C.

The same process may be performed for one or more other sound sources, not shown, such that that they will be perceived by the user as coming from respective directions with respect to the user.

Users who wear certain audio capture devices may not get an optimum user experience when experiencing immersive audio, e.g., as in FIG. 2. This is particularly the case for audio capture devices such as hearing aids or earphone devices operable in a directivity, or accessibility mode for hearing assistance.

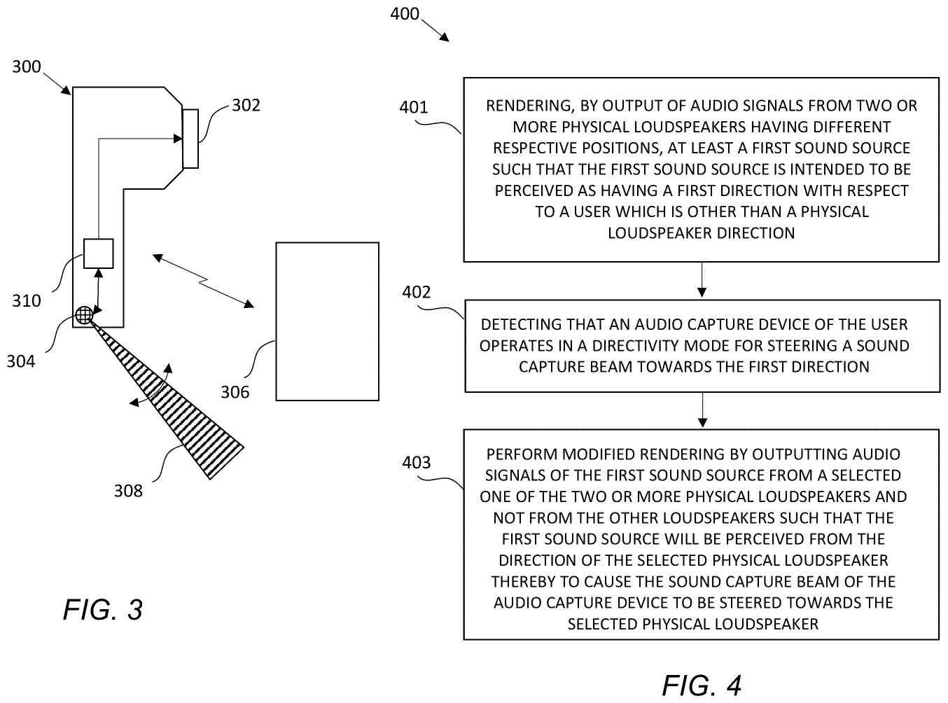

FIG. 3 is a schematic view of an example audio capture device, comprising an earphone 300. Although not shown, the earphone 300 may comprise one of a pair of earphones.

The earphone 300 may comprise a loudspeaker 302 which, in use, is to be placed over or within a user's ear, and a microphone array 304. The earphone 300 may be configured in use to provide hearing assistance when operating in a so-called directivity (or accessibility) mode, which may be a default mode, or one which is enabled by means of a control input to the earphone or through another device, such as a user device 306 in paired communication with the earphone. The control input may be provided by any suitable means, e.g., a touch input, a gesture, or a voice input.

The microphone array 304 may be configured to steer a sound capture beam 308 towards the perceived direction of particular sounds, such as particular sound objects or towards a direction relative to the earphone such as frontal direction.

More specifically, the earphone 300 may comprise a signal processing function 310 which spatially filters the surrounding audio field such that sounds coming from one or more particular directions or from within a predetermined range of direction(s) are amplified over sounds from other directions. These directions effectively form the referred-to sound capture beam 308. It will be seen that the direction and size of the sound capture beam 308 can be steered under the control of the signal processing function 310 which amplifies and passes captured sounds within the sound capture beam to the loudspeaker 302.

The signal processing function 310 may be configured using known methods to steer the sound capture beam 308 in a direction towards one or more particular sound objects or directions relative to the earphone.

The particular sounds objects may comprise a predetermined type of sound object, such as a speech sound object and/or a sound object which is in a particular direction with respect to the earphone, e.g. towards its front side. The audio processor 102 may infer based on said predetermined type or respective direction of the sound object that it is of importance to the user.

Returning to FIG. 2, if the user at position 106 is wearing an audio capture device operating in a directivity mode, e.g., the earphone 300, the sound capture beam 308 may be directed by the signal processing function 310 in the first direction 202 because it is the perceived direction of the first sound source 200. However, amplification will likely be sub-optimal and may affect intelligibility of the first sound source 200. Amplification may be sub-optimal because the sound capture beam 308 is directed towards a location where there is no loudspeaker and attenuation may be performed on audio signals, e.g. the loudspeaker audio signals, outside of the sound capture beam.

Also, the size and/or steering of the sound capture beam 308 by the signal processing function 310 may be affected. Overall, user experience may be negatively affected.

According to one or more example embodiments, the rendering of one or more sound sources may be modified to mitigate against such issues.

FIG. 4 is a flow diagram showing operations 400 that may be performed by one or more example embodiments. The operations 400 may be performed by hardware, software, firmware or a combination thereof. The operations 400 may be performed by one, or respective, means, a means being any suitable means such as one or more processors or controllers in combination with computer-readable instructions provided on one or more memories. The operations 400 may, for example, be performed by the audio processor 102 already-described in relation to the FIG. 2 example.

A first operation 401 may comprise rendering, by output of audio signals from two or more physical loudspeakers having different respective positions, at least a first sound source such that the first sound source is intended to be perceived as having a first direction with respect to a user which is other than a physical loudspeaker direction.

A second operation 402 may comprise detecting that an audio capture device of the user operates in a directivity mode for steering a sound capture beam towards the first direction.

A third operation 403 may comprise, responsive to the detecting, performing modified rendering by outputting audio signals of the first sound source from a selected one of the two or more physical loudspeakers and not from the other physical loudspeaker(s) such that the first sound source will be perceived from the direction of the selected physical loudspeaker.

In this way, an audio capture device operating in a directivity mode will steer its sound capture beam towards the selected physical loudspeaker which mitigates against the above-mentioned issues.

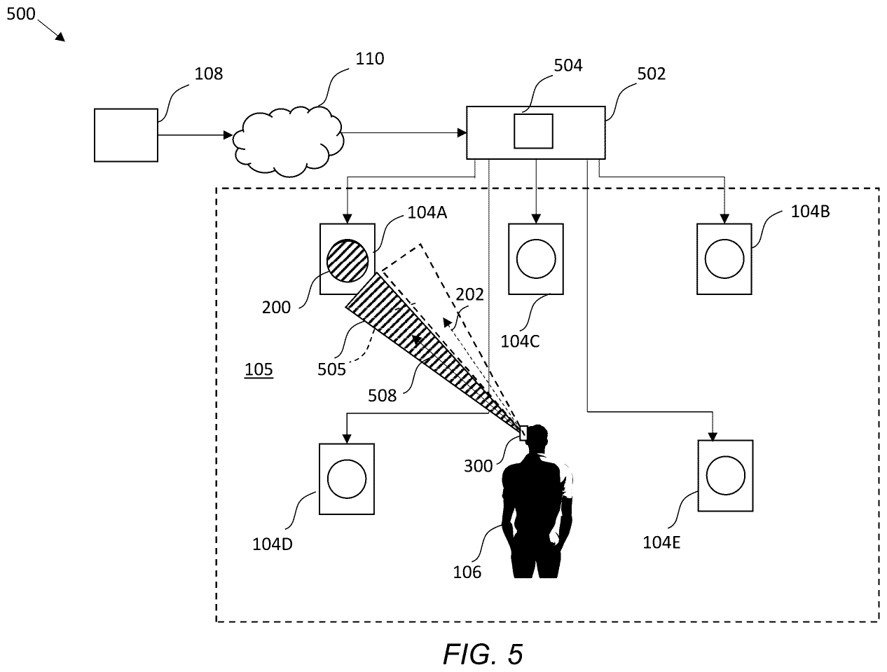

FIG. 5 shows a system 500 for output of immersive audio according to one or more example embodiments.

The system 500 is similar to that shown in FIG. 2. The system 500 comprises an audio processor 502 which includes a rendering means 504 configured to perform the operations 400 described with reference to FIG. 4.

The rendering means 504 may be configured to operate, at a first time, in accordance with the first operation 401.

Hence the rendering means 504 may output, or intend to output, audio signals for the first sound source 200 from the first and third loudspeakers 104A, 104C. The first sound source 200 is, or is intended to be, perceived as coming from the first direction 202.

The rendering means 504, or another component or function of the audio processor 502, may be configured to operate according to the second operation 402.

That is, the rendering means 504 or other component or function may detect that the user at position 106 is wearing an audio capture device, in this case the earphone 300 of FIG. 3, which operates in a directivity mode for steering a sound capture beam 505 (shown in dashed line) towards the first direction 202.

The second operation 402 may involve the rendering means 504 or other component or function receiving a signal indicating that the earphone 300 operates in a directivity mode.

The received signal may be transmitted by the earphone 300, or an associated device such as the user device 306.

The received signal may be transmitted responsive to a discovery signal transmitted by the rendering means 504 or other component or function of the audio processor 502 to the earphone 300 or the user device 306. Alternatively, the signal may be transmitted responsive to user enablement of the directivity mode at the earphone 300 during performance of the first operation 401. Signal communications between the audio processor 502 and the earphone 300 or user device 306 may be by means of any suitable wireless protocol, such as by WiFi, Bluetooth, Zigbee or any variant thereof. For example, there may be a paired relationship between the audio processor 502 and the earphone 300 which automatically establishes a link and signalling between said devices when the latter is in communication range of the former.

The second operation 402 may be performed responsive to determining that the earphone 300 is in proximity to the audio processor 502.

The rendering means 504 may then responsively perform the third operation 403.

That is, the rendering means 504 modifies its rendering by outputting audio signals of the first sound source 200 from, in this case, the first loudspeaker 104A and not from the third loudspeaker 104C.

In consequence, the earphone 300 will steer its sound capture beam 505 towards a second direction 508 which aligns with the first loudspeaker 104A. This avoids or mitigates against the above-mentioned disadvantages.

In some example embodiments, the audio processor 502 may be configured such that the selected loudspeaker is has a direction with respect to the user that is closest to the first direction.

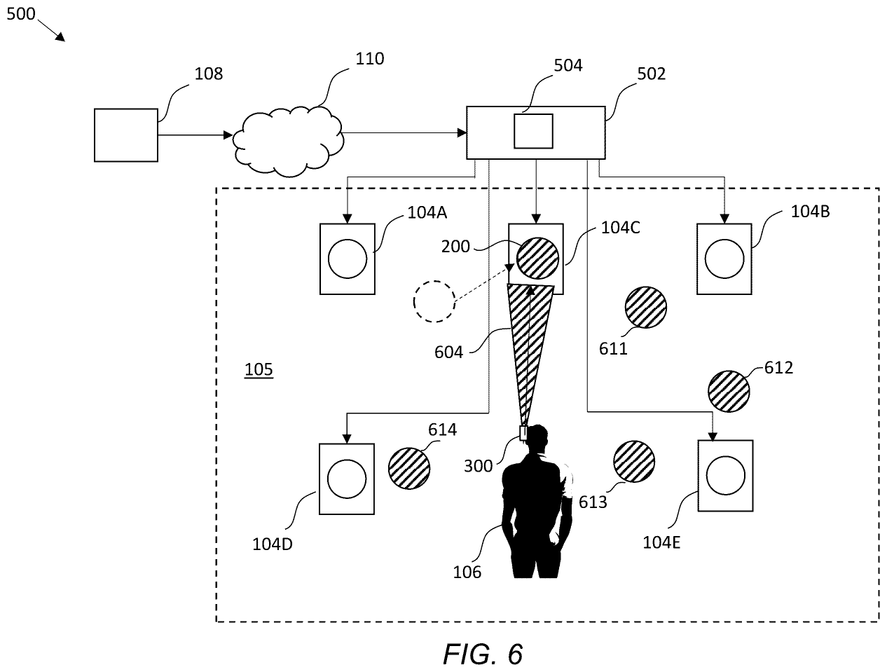

In this respect, the audio processor 502 may be configured to determine the direction of at least the first and third loudspeakers 104A, 104C with respect to the user position 106 (e.g. based on knowing or determining their respective positions) and, based on knowing the first direction with respect to the user, the third loudspeaker may be selected. In another approach, the audio processor 502 may be further configured to determine, based on the first direction 202, the intended spatial position 106 of the first sound source 200 with respect to at least the first and third loudspeakers 104A, 104C. As shown in FIG. 6, the audio processor 502 may determine that the third loudspeaker 104C has the closest direction to the first direction 202 shown in FIG. 2 and hence becomes the selected loudspeaker. The earphone 300 will steer its sound capture beam 505 towards the third loudspeaker 104C which may further improve intelligibility.

In some example embodiments, the third operation 403 is performed in further response to the audio processor 502 detecting that the first sound source is of interest to the user. For example, the third operation 403 may be performed if the first sound source is a predetermined type of sound, such as speech-type sound. The type of sound may be indicated with the audio data, e.g. in metadata, or may be determined using signal processing methods such as by applying the audio data to one or more classifier models for determining audio type(s).

Alternatively, or additionally, the third operation 403 may be performed by the audio processor 502 if the intended direction (i.e. the first direction 202) of the first sound source 200 corresponds to a user's head direction. In this respect, the audio processor 502 may, with knowledge of the user's position 106, determine a user's head direction and detect that the first sound source 200 is of interest if the first direction 202 is within a predetermined angular range of the user's head direction. The user's position 106 may be determined by the audio processor 502, or by another device and transmitted to the audio processor, using known methods, such as by use of ranging signals transmitted from or to reference positions and multilateration processing.

The user's head direction may be determined using conventional methods, such as based on the orientation of the earphone 300 when worn. A front facing part of the earphone 300 may be assumed to correspond with the user's head direction.

In some example embodiments, the first operation 401 may comprise rendering, or intending to render, one or more other sound sources such that they, or at least some, are intended to be perceived as coming from respective directions with respect to the user's position 106. Again, this may be by means of the audio processor 502 output other audio signals for said one or more other sound sources using two or more loudspeakers of the first to fifth loudspeakers 104A-104E.

In this case, the audio processor 502 may perform the third operation 403 only for the first sound source 200 on the basis that it is of interest to the user. The rendering of the other sound sources may remain unaffected or may be modified in one or more other ways, as will be explained below.

FIG. 6 shows the FIG. 5 system 500 in which second to fifth sound sources 611-614 are shown rendered at respective directions with respect to the user.

It will be seen that only the first sound source 200 experiences modified rendering which effectively moves it to the direction of the third loudspeaker 104C. This may be because the first sound source 200 is detected as being of interest to the user, e.g. because it is speech and/or is within the user's head direction.

The third loudspeaker 104C may be selected because its direction with respect to the user is closest to the first direction and/or because it is closest intended spatial position of the first sound source. Hence a sound capture beam 604 of the earphone 300 steers towards the direction of the third loudspeaker 104C.

Some example embodiments may include applying a different form of modified rendering to audio signals of at least some of the other sound sources for further enhancing user experience.

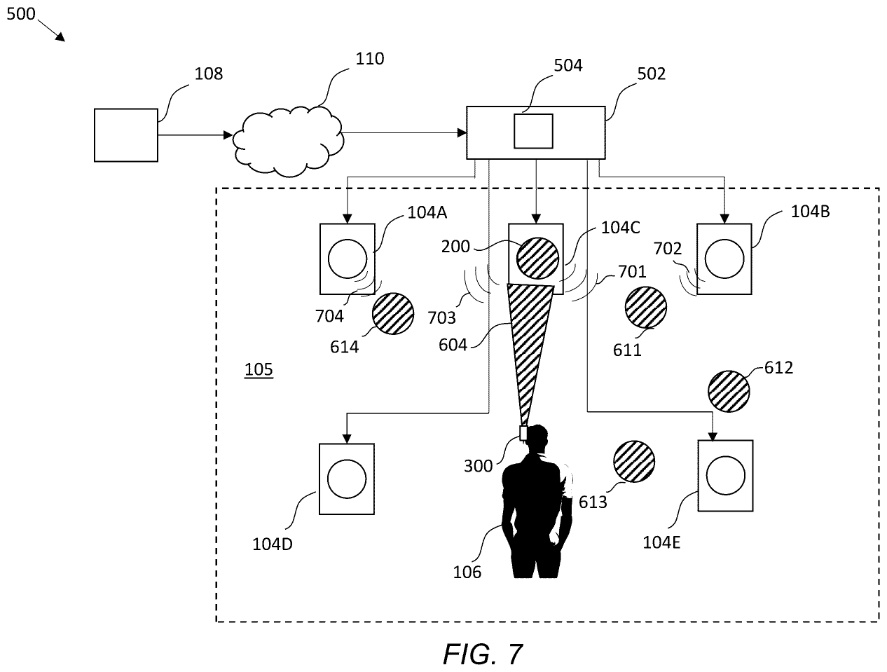

FIG. 7 shows the FIG. 5 system 500 in which second to fifth sound sources 611-614 are shown rendered at respective directions with respect to the user. The modified rendering described above for FIG. 6 (the movement of the first sound source 200) is already shown.

It will be seen that the second sound source 611 is rendered using a first set of audio signals 701 from the third loudspeaker 104C and a second set of audio signals 702 from the second loudspeaker 104B. It will also be seen that the fifth sound source 614 is rendered using a third set of audio signals 703 from the third loudspeaker 104C and a fourth set of audio signals 704 from the first loudspeaker.

Because the third loudspeaker 104C is in this case the selected loudspeaker for the first sound source 200, the following modifications may be performed.

In one example, the first sets of audio signals 701, 703 for the second and fifth sound sources 611, 614 may be rendered with reduced reverberation (clean/reverb ratio) using one or more known methods, for example as set out in the MPEG-I standards.

Alternatively, or additionally to the above, the second sets of audio signals 702, 704 for the second and fifth sound sources 611, 614 may be rendered with increased reverberation (clean/reverb ratio) using one or more known methods, for example as set out in the MPEG-I standards. This may serve to compensate for reduced reverberation of the first sets of audio signals 701, 703 if that method is used.

Alternatively, or additionally to the above, the first sets of audio signals 701, 703 for the second and fifth sound sources 611, 614 may be rendered with reduced (or muted) output volume. In this way, the audio signals for the first sound source 200 will tend to mask the audio signals 701, 703 for the second and fifth sound sources 611, 614, especially if they share a reasonable amount of common frequencies.

Alternatively, or additionally to the above, at least part of the audio signal may be rendered without panning using a smaller number of loudspeakers.

Alternatively, or additionally to the above, at least part of the audio signal may be rendered using a smaller number of loudspeakers.

Alternatively, at least the first sets of audio signals 701, 703 for the second and fifth sound sources 611, 614 may be output by one or more different loudspeakers, i.e. other than the third loudspeaker 104C, such that the second and fifth sound sources 611, 614 are perceived as coming from different directions, i.e., the direction(s) of said one or more other loudspeakers.

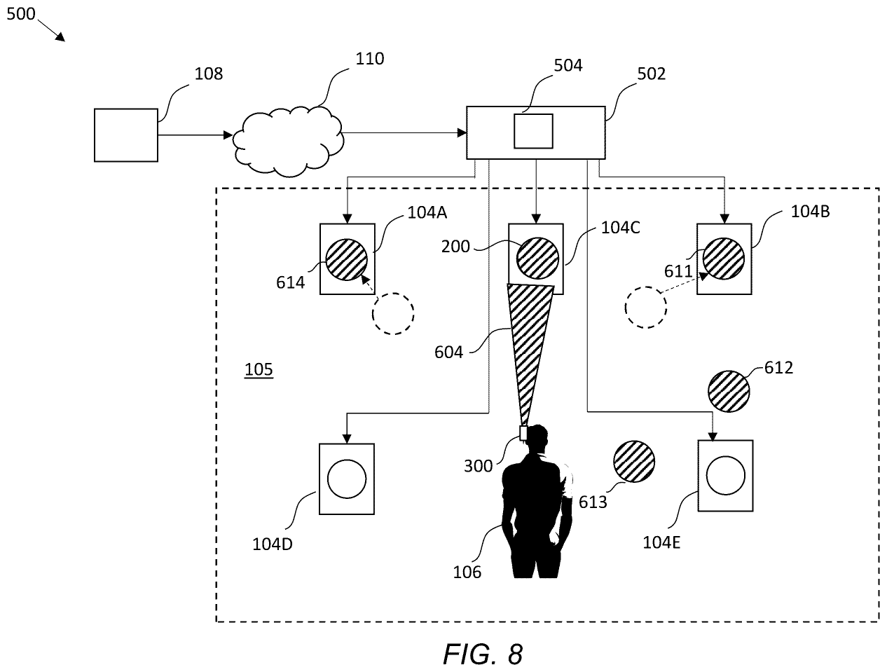

FIG. 8 shows that audio signals for the second and fifth sound sources 611, 614 are output by, respectively, the second and first loudspeakers 104B, 104A and audio signal contribution is made by the third loudspeaker 104C. In this way, the respective perceived directions of the second and fifth sound sources 611, 614 are changed, making the first sound source 200 more perceivable whilst keeping the second and fifth sound sources in the overall audio scene.

In some example embodiments, the different loudspeakers 104B, 104A are selected based on which is closest to the intended spatial position of said second and fifth sound sources 611, 614.

Example embodiments may be performed using object rendering with a capable renderer such as an MPEG-I renderer.

In some example embodiments, the amount of sound source modification, such as the amount of change in perceived direction for the one or more sound sources, may be dependent on the type of audio content which comprises said sound sources.

For example, example embodiments may comprise determining the type of audio content and determining the amount of sound source modification to perform based on said determined type.

For example, certain types of audio content may be treated differently from others. For example, music may be treated differently from ambience. For example, if the audio content accompanies video content, the amount of sound source modification may be different than if it did not accompany video content. Where there is accompanying video content, it may for example be assumed (or indicated in accompanying metadata) that the audio direction of one or more sound sources is critical; for example speech may be considered critical to render from an appropriately located loudspeaker or that corresponding to the user's head direction whereas other audio sources, e.g. ambient sounds, may be less critical and one or more of the other effects (e.g. moving to other loudspeakers) may be used.

The content creator may indicate, e.g. via metadata associated with the audio content, one or more preferences indicative of what modification(s) are permitted for which sound sources and/or when in the course of rendering. For example, the metadata may indicate how much deviation from original sound source directions is permitted, if at all at certain times, in comparison to improved intelligibility thanks to said modification(s). The metadata may be embedded into scene data, e.g. in MPEG-I's accessibility mode.

Alternatively, or additionally, a user may determine what modification(s) are permitted for which sound sources and/or when in the course of rendering. A user may provide input to the render, e.g. via the audio processor 502, via a suitable user interface to set one or more preferences in this regard.

Example embodiments are applicable to object and non-object-based audio rendering methods. Ambisonics is an example of a non-object-based audio rendering method, for which rendering may comprise beamforming on signal levels to focus on important sound sources such as speech, and fitting the direction of the beam towards a physical loudspeaker in the output rendering (ambisonics panning) to achieve a similar experience as with objects. Thus, the ambisonics signal can be rotated during panning such that the positions of the one or more sound sources of interest coincide with loudspeaker positions, thus leading to sharper reproduction. Ambisonics beamforming can be used to enhance the sound sources. Loudspeaker channel based methods such as 5.1 are an example of non-object based audio rendering methods. Entire channels may be modified so that fewer loudspeakers are used to render the channel based signals.

### EXAMPLE APPARATUS

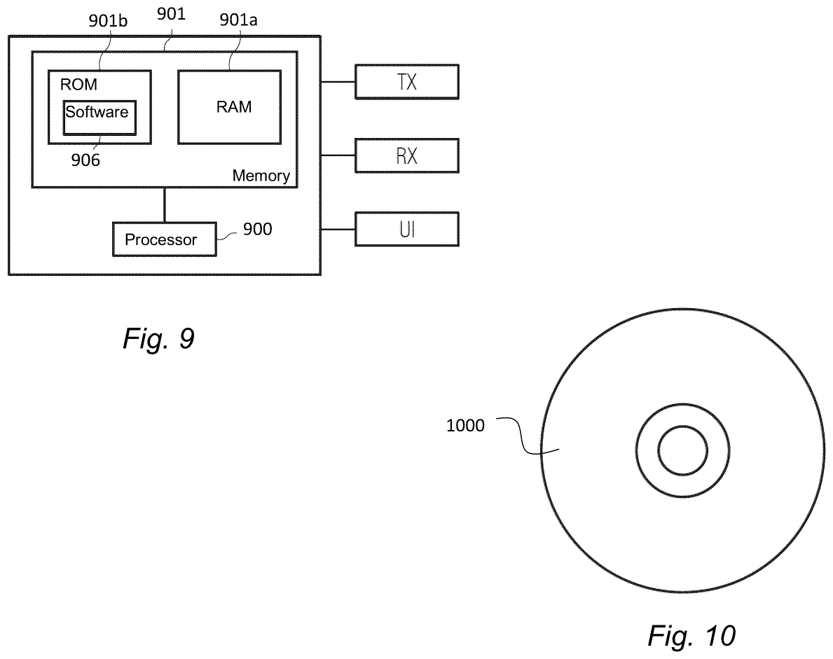

FIG. 9 shows an apparatus according to some example embodiments. The apparatus may be configured to perform the operations described herein, for example operations described with reference to any disclosed process. The apparatus comprises at least one processor 900 and at least one memory 901 directly or closely connected to the processor. The memory 901 includes at least one random access memory (RAM) 901a and at least one read-only memory (ROM) 901b. Computer program code (software) 906 is stored in the ROM 901b. The apparatus may be connected to a transmitter (TX) and a receiver (RX). The apparatus may, optionally, be connected with a user interface (UI) for instructing the apparatus and/or for outputting data. The at least one processor 900, with the at least one memory 901 and the computer program code 906 are arranged to cause the apparatus to at least perform at least the method according to any preceding process, for example as disclosed in relation to the flow diagram of FIG. 4 and related features thereof.

FIG. 10 shows a non-transitory media 1000 according to some embodiments. The non-transitory media 1000 is a computer readable storage medium. It may be e.g. a CD, a DVD, a USB stick, a blue ray disk, etc. The non-transitory media 1000 stores computer program instructions, causing an apparatus to perform the method of any preceding process for example as disclosed in relation to the flow diagram of FIG. 4 and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

A memory may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-17. (canceled)

18. An apparatus comprising:
at least one processor; and
at least one memory storing instructions that, when executed by the at least one processor, cause the apparatus at least to:
render, by output of audio signals from two or more physical loudspeakers having different respective positions, at least a first sound source such that the first sound source is intended to be perceived as having a first direction with respect to a user which is other than a physical loudspeaker direction; and
detect that an audio capture device of the user operates in a directivity mode for steering a sound capture beam towards the first direction;
wherein the rendering, responsive to the detecting, comprises performing modified rendering by outputting audio signals of the first sound source from a selected one of the two or more physical loudspeakers and not from the other one or more physical loudspeakers such that the first sound source will be perceived from the direction of the selected physical loudspeaker thereby to cause the sound capture beam of the audio capture device to be steered towards the selected physical loudspeaker.

19. The apparatus of claim 18, wherein the selected physical loudspeaker is that which has a direction with respect to the user that is closest to the first direction.

20. The apparatus of claim 18, wherein the apparatus is further caused to:
detect that the first sound source is of interest to the user; and
perform the modified rendering in response to detecting that the audio capture device operates in a directivity mode only if the first sound source is detected to be of interest to the user.

21. The apparatus of claim 20, wherein the detecting that the first sound source is of interest to the user comprises detecting that the first sound source is a predetermined type of sound.

22. The apparatus of claim 21, wherein the predetermined type of sound comprises speech-type sound.

23. The apparatus of claim 20, wherein the apparatus is further caused to:
determine a head direction of the user,
wherein the detecting that the first sound source is of interest to the user comprises detecting that the first direction is within a predetermined angular range of the head direction of the user.

24. The apparatus of claim 20, wherein the rendering comprises rendering, by output of other audio signals from the two or more physical loudspeakers, one or more other sound sources such that they are intended to be perceived as coming from respective directions with respect to the user, and
wherein the modified rendering is performed so that the first sound source will be perceived from the direction of the selected physical loudspeaker only for the first sound source and not the other sound sources.

25. The apparatus of claim 24, wherein the apparatus is further caused to:
determine that, for said other audio signals of said one or more other sound sources, a first set of said other audio signals are, or are intended to be, output only by the selected physical loudspeaker and a second set of said other audio signals are, or are intended to be, output by one or more other physical loudspeakers;
wherein the rendering comprises, responsive to said determination, performing other modified rendering of at least one of said first set of other audio signals or said second set of other audio signals of the one or more other sound sources.

26. The apparatus of claim 25, wherein said other modified rendering comprises at least one of:
rendering said first set of audio signals for the one or more other sound sources with reduced reverberation; or
rendering said second set of audio signals for the one or more other sound sources with increased reverberation.

27. The apparatus of claim 25, wherein said other modified rendering comprises outputting said first set of audio signals for the one or more other sound sources from a different physical loudspeaker to the selected physical loudspeaker.

28. The apparatus of claim 27, wherein, for a particular other sound source, the different physical loudspeaker is that which is has a direction with respect to the user that is closest to the direction of said particular other sound source with respect to the user.

29. The apparatus of claim 25, wherein said other modified rendering comprises rendering said first set of audio signals for the one or more other sound sources by rendering them at reduced volume.

30. The apparatus of claim 25, wherein the apparatus is further caused to:
determine respective types of audio content which comprise the first sound source and the one or more other sound sources; and
determine an amount of said other modified rendering to perform based on the determined respective types of audio content.

31. The apparatus of claim 25, wherein the apparatus is further caused to:
receive metadata associated with audio content which comprises the first sound source and the one or more other sound sources; and
determine an amount of said other modified rendering to perform based on the received metadata.

32. The apparatus of claim 18, wherein the rendering of the at least first audio source is performed by an MPEG-I renderer.

33. A method, comprising:
rendering, by output of audio signals from two or more physical loudspeakers having different respective positions, at least a first sound source such that the first sound source is intended to be perceived as having a first direction with respect to a user which is other than a physical loudspeaker direction;
detecting that an audio capture device of the user operates in a directivity mode for steering a sound capture beam towards the first direction; and
responsive to the detecting, performing modified rendering by outputting audio signals of the first sound source from a selected one of the two or more physical loudspeakers and not from the other one or more physical loudspeakers such that the first sound source will be perceived from the direction of the selected physical loudspeaker thereby to cause the sound capture beam of the audio capture device to be steered towards the selected physical loudspeaker.

34. The method of claim 33, wherein the selected physical loudspeaker is that which has a direction with respect to the user that is closest to the first direction.

35. The method of claim 33, further comprising:
detecting that the first sound source is of interest to the user; and
performing the modified rendering in response to detecting that the audio capture device operates in a directivity mode only if the first sound source is detected to be of interest to the user.

36. The apparatus of claim 35, wherein the detecting that the first sound source is of interest to the user comprises detecting that the first sound source is a predetermined type of sound.

37. A non-transitory computer readable medium comprising program instructions stored thereon for performing at least the following:
rendering, by output of audio signals from two or more physical loudspeakers having different respective positions, at least a first sound source such that the first sound source is intended to be perceived as having a first direction with respect to a user which is other than a physical loudspeaker direction;
detecting that an audio capture device of the user operates in a directivity mode for steering a sound capture beam towards the first direction; and
responsive to the detecting, performing modified rendering by outputting audio signals of the first sound source from a selected one of the two or more physical loudspeakers and not from the other one or more physical loudspeakers such that the first sound source will be perceived from the direction of the selected physical loudspeaker thereby to cause the sound capture beam of the audio capture device to be steered towards the selected physical loudspeaker.
